(19) United States
(12) Patent Application Publication
(10) Pub. No.: US 2016/0274451 A1
(43) Pub. Date: Sep. 22, 2016

(54) MULTI-DIRECTION IMAGE PROJECTING SYSTEM

(71) Applicant: Louis Robinson, Los Angeles, CA (US)

(72) Inventor: Louis Robinson, Los Angeles, CA (US)

(21) Appl. No.: 14/663,770

(22) Filed: Mar. 20, 2015

(51) Int. Cl. G03B 37/04; G03B 21/14

(52) U.S. Cl. CPC G03B 37/04; G03B 21/145

(57) ABSTRACT

A multi-direction image projecting system includes a housing that has a top wall, a bottom wall and a perimeter wall which is attached to and extends between each of the top and bottom walls. A plurality of image projectors is mounted within the housing and each is configured to project a visible image on a remote surface. Each of the image projectors is directed in a different direction than a remaining one of the projectors.

### BACKGROUND OF THE DISCLOSURE

### Field of the Disclosure

The disclosure relates to image projecting devices and more particularly pertains to a new image projecting device for allowing a person to simultaneously project images in a plurality of different directions and allows for all images to be merged together to form a panoramic view extending around all walls of a room.

### SUMMARY OF THE DISCLOSURE

An embodiment of the disclosure meets the needs presented above by generally comprising a housing that has a top wall, a bottom wall and a perimeter wall which is attached to and extends between each of the top and bottom walls. A plurality of image projectors is mounted within the housing and each is configured to project a visible image on a remote surface. Each of the image projectors is directed in a different direction than a remaining one of the projectors.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a multi-direction image projecting system according to an embodiment of the disclosure.

FIG. 2 is a front view of an embodiment of the disclosure.

FIG. 3 is a bottom view of an embodiment of the disclosure.

FIG. 4 is a top perspective view of a remote control of an embodiment of the disclosure.

FIG. 5 is a top view of an embodiment of the disclosure.

FIG. 6 is a schematic view of an embodiment of the disclosure.

### DESCRIPTION OF THE PREFERRED EMBODIMENT

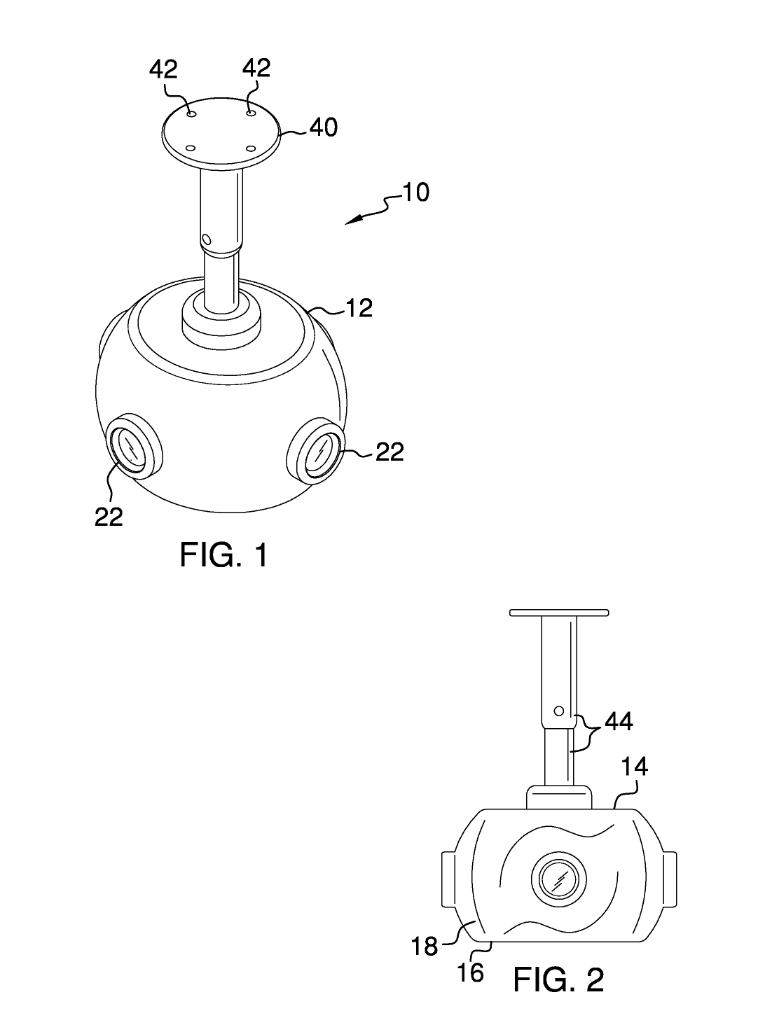

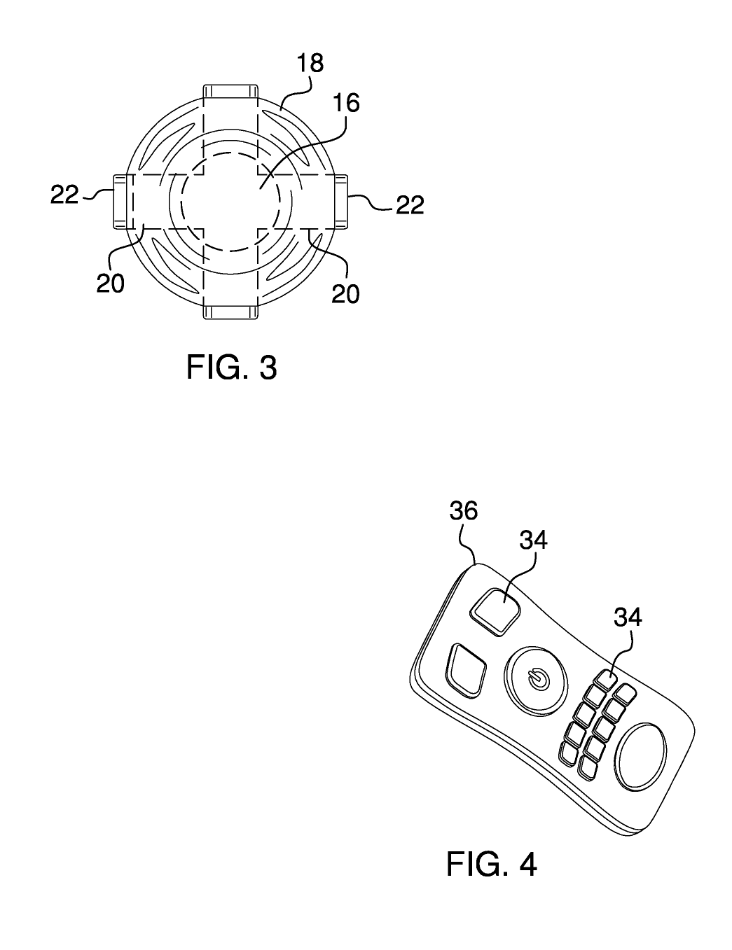

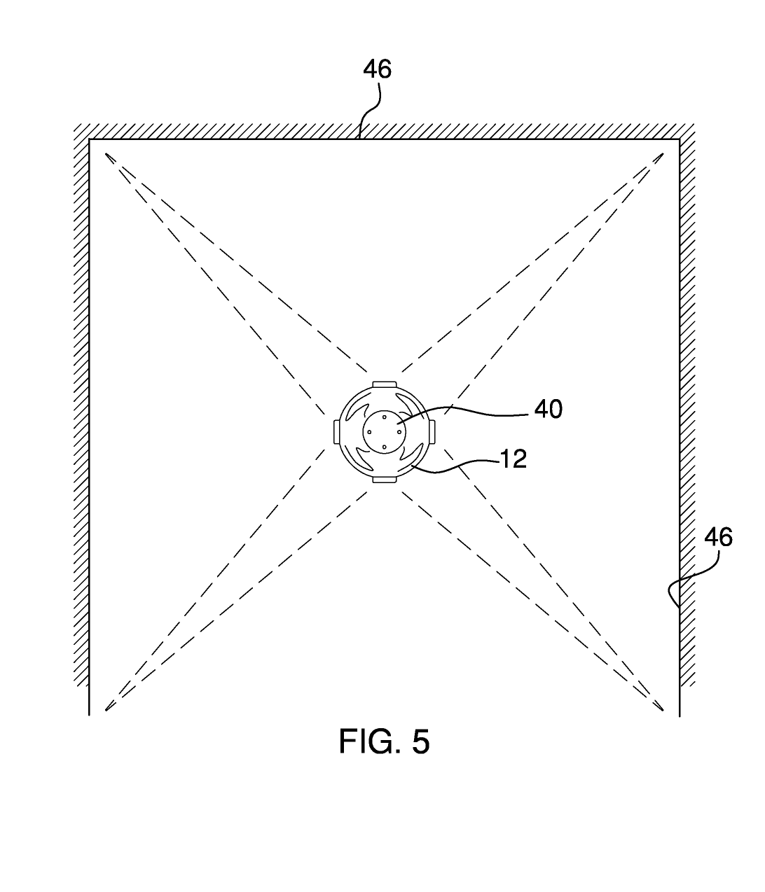

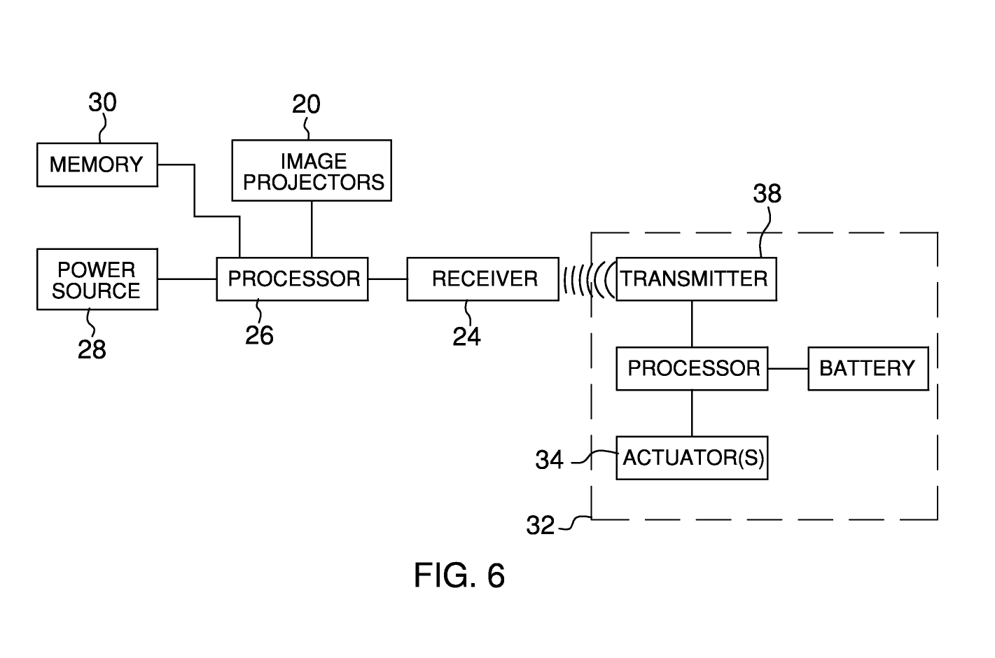

With reference now to the drawings, and in particular to FIGS. 1 through 6 thereof, a new image projecting device embodying the principles and concepts of an embodiment of the disclosure and generally designated by the reference numeral 10 will be described.

As best illustrated in FIGS. 1 through 6, the multi-direction image projecting system 10 generally comprises a housing 12 that has a top wall 14, a bottom wall 16 and a perimeter wall 18 which is attached to and extends between each of the top 14 and bottom 16 walls. While the housing 12 is shown having a generally spherical shape with flattened top and bottom walls, alternate shapes may be utilized.

A plurality of image projectors 20 is mounted within the housing 12 and each is configured to project a visible image on a remote surface. Each of the image projectors 20 is directed in a different direction than a remaining one of the projectors 20. It should be understood that the term “image projector” is being used in a generic manner to describe the actual emitting of the image. As such, it should be understood that the system 10 may utilize one light source and multiple screens (LED or LCD, for instance), for instance such that each image projector 20 will include its own LED or LCD through which light passes through from the light source. Alternate structures such as Liquid Crystal on Silicone (LCOS) may be used as is found in what is known as pico or pocket projectors. The light source may comprise one or more LEDs or other types of lighting sources. Such projection systems using LED, LCD and LCOS screens are conventional. Alternatively, a single screen may be utilized and the image split by way of mirrors to form multiple, discrete images. However, it may be advantageous to utilize one screen per image emitted so that different images may be simultaneously projected.

The plurality of image projectors 20 may include four image projectors 20 and the system 10 will generally include at least three image projectors 20. The image projectors 20 may be angled 90° with respect to each other and each is positioned within a horizontal plane. If only three image projectors 20 are used, they may be positioned that a middle image projector 20 is 90° offset from the remaining two image projectors 20 which are directed in opposite directions with respect to each other. Each of the projectors 20 includes a lens 22 mounted on the perimeter wall 18. Each lens 22 is adjustable to alter a size of the visible image. The lenses 22 may also be configured to allow for focusing. Though not shown, the lenses 22 may be mechanically actuated by a remote control as discussed below. The images projected may be blended so that a single image is formed from all emitted images. In this way, the images may be knit together from a single to completely surrounding a person positioned in a room containing the system 10.

A receiver 24, for receiving wireless signals, is positioned within the housing 12. The receiver 24 may be configured to receive any or multiple types of wireless transmissions including Wi-Fi, Bluetooth, infrared and other conventionally used wireless signals. A processor 26 is positioned within the housing 12 and is electrically coupled to the receiver 24 and to the image projectors 20. A power source 28 is electrically coupled to the processor 26. The power source 28 may be a battery mounted within the housing 12. Alternatively, the power source 28 may comprise being hardwired to a dwelling in which the housing 12 is mounted or a power cord pluggable into an electrical outlet. Further, electronic memory 30 may be mounted within the housing 12 and electrically coupled by the processor 26. Thus, thus processor 26 can access the memory 30 to retrieve images or videos to be displayed by the image projectors 20.

A control 32 is provided which allows for accessing the functions and operations of the image projectors 20 and in particularly the processor 26. The processor 26 may be programmed such that the image projectors 20 each project a same image or a different image, as well as still images, videos, or a slideshow of still images. The control 32 is generally conventional and includes one or more actuators 34, and may include a touchscreen, for directing the processor 26 as needed. It should be understood that at least one of the image projectors 20 may be used, as needed, to project alpha numeric symbols by the processor 26 to act as an interface when a user of the system 10 is operating the system 10. The control 32 may include a remote control 36 which includes a transmitter 38 for transmitting wireless signals to the receiver 24 wherein the transmitter 38 is operationally coupled to the one or more actuators 34. The actuator(s) 34 is actuated to selectively turn on the image projectors 20 and selectively project an image out of each of the image projectors 20. Moreover, the remote control 38 may further include memory containing electronic data files, of images or full motion videos, to be projected. The remote control 36 may thereby be used to transmit these data files to the processor 26 for immediate viewing or for storage on the memory 30. The control 32 may comprise a cellular phone having wireless capabilities and which may access non-system connected electronic memory such as remote computers. The control 32 may also be utilized to drive motors mounted in the housing 12 and mechanically coupled to the lenses 22 to control the lenses 22.

A mount 40 is attached to the housing 12 and extends upwardly therefrom. The mount 40 is configured to be mounted to a ceiling. As can be seen, the mount 40 may include a plurality of apertures 42 extending therethrough for receiving fasteners to secure the mount 40 to the ceiling. Generally the mount 40 is attached to the top wall 14 such that the housing 12 is suspended directly below the mount 40. The mount 40 may include sections 44 rotatable with respect to each other to allow rotation of the housing 12.

In use, the housing 12 is mounted or positioned within a room such that it is generally centered within the room. The image projectors 20 are turned on so that each wall 46 of the room, or at least three of the walls 46, have an image projected thereon. This will allow a room to have its appearance quickly altered. Moreover, it will allow a person to set a particular mood for a room. The system 10 may further be modified to be used with video games and the like. As such, the system 10 may be operationally paired with a sound emitting assembly for allowing audio from videos and video games.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A multi-directional image projecting system comprising:
a housing having a top wall, a bottom wall and a perimeter wall being attached to and extending between each of said top and bottom walls; and
a plurality of image projectors being mounted within said housing and being configured to project a visible image on a remote surface, each of said image projectors being directed in a different direction than a remaining one of said projectors.

2. The system according to claim 1, wherein said image projectors are angled 90° with respect to each other and each being positioned within a horizontal plane.

3. The system according to claim 2, wherein said plurality of image projectors includes four image projections.

4. The system according to claim 1, wherein said plurality of image projectors includes at least four image projections.

5. The system according to claim 1, wherein each of said projectors includes a lens mounted on said perimeter wall, each lens being adjustable to alter a size of said visible image.

6. The system according to claim 1, further including:
a receiver being positioned within said housing; and
a processor being positioned within said housing and being electrically coupled to said receiver and to said image projectors.

7. The system according to claim 6, further including a remote control including a transmitter for transmitting wireless signals to said receiver, said remote control including at least one actuator being operationally coupled to said transmitter, said at least one actuator being actuated to selectively turn on said image projectors and selectively project an image out of each of said image projectors.

8. The system according to claim 1, further including a mount being attached to said housing and extending upwardly therefrom, said mount being configured to be mounted to a ceiling.

9. A multi-directional image projecting system comprising:
a housing having a top wall, a bottom wall and a perimeter wall being attached to and extending between each of said top and bottom walls;
a plurality of image projectors being mounted within said housing and being configured to project a visible image on a remote surface, each of said image projectors being directed in a different direction than a remaining one of said projectors, said image projectors being angled 90° with respect to each other and each being positioned within a horizontal plane, each of said projectors including a lens mounted on said perimeter wall, each lens being adjustable to alter a size of said visible image;
a receiver being positioned within said housing;
a processor being positioned within said housing and being electrically coupled to said receiver and to said image projectors;
a remote control including a transmitter for transmitting wireless signals to said receiver, said remote control including at least one actuator being operationally coupled to said transmitter, said at least one actuator being actuated to selectively turn on said image projectors and selectively project an image out of each of said image projectors; and
a mount being attached to said housing and extending upwardly therefrom, said mount being configured to be mounted to a ceiling.
